(19) United States
(12) Patent Application Publication
(10) Pub. No.: US 2019/0232252 A1
(43) Pub. Date: Aug. 1, 2019

(54) CHROMATOGRAPHIC MATERIAL AND METHODS FOR THE SYNTHESIS THEREOF

(71) Applicants: DIONEX CORPORATION, Sunnyvale, CA (US); THERMO ELECTRON MANUFACTURING LIMITED, Runcorn (GB)

(72) Inventors: Kevin Skinley, Runcorn (GB); Xiaodong Liu, Cupertino, CA (US); Christopher A. Pohl, Union City, CA (US); Harald Ritchie, Chester (GB)

(21) Appl. No.: 16/378,296

(22) Filed: Apr. 8, 2019

Related U.S. Application Data
(63) Continuation of application No. 14/175,689, filed on Feb. 7, 2014.

(51) Int. Cl. B01J 20/283; B01J 20/28; B01J 20/10; B01J 20/287; B01J 20/30; B01J 20/22

(52) U.S. Cl. CPC B01J 20/283; B01J 2220/42; B01J 20/103; B01J 20/287; B01J 20/28057; B01J 20/3085; B01J 20/22; B01J 20/28004; B01J 20/28016; B01J 20/28019; B01J 20/28059; B01J 20/28061; B01J 20/28083; B01J 20/28085; B01J 20/3071; B01J 20/3078; B01J 2220/44; B01J 20/28078

(57) ABSTRACT

A particulate material for chromatographic use comprising silica particles is provided having a skeleton structure containing silsesquioxane cage moieties. The material is useful as a chromatographic material, for example in HPLC. The silica particles may be hybrid organo-silica particles wherein the silsesquioxane moieties comprise a cage structure having silicon atoms positioned at corners of the cage wherein one or more silicon atoms positioned at the corners of the cage carry an organic group. A preferred method of preparing the particulate material comprises hydrolysing a silsesquioxane as a co-component of a hydrolysis mixture, especially in a Stöber or modified Stöber process.

### CROSS REFERENCE TO RELATED APPLICATIONS

This application is a continuation under 35 U.S.C. § 120 and claims the priority benefit of co-pending U.S. patent application Ser. No. 14/175,689 filed Feb. 7, 2014. The disclosure of the foregoing application is incorporated herein by reference.

### FIELD OF THE INVENTION

This invention relates to the field of chromatographic sample separation that includes liquid chromatography and solid phase extraction and, in particular, it relates to material and the synthesis of material for use as a stationary phase in chromatographic sample separation.

### BACKGROUND OF THE INVENTION

Liquid chromatography (LC), e.g. HPLC and UHPLC, and solid phase extraction (SPE) are used routinely in both analytical and preparative chromatography applications. In these chromatographic techniques, separation of a sample comprising a mixture of components is achieved by conveying the sample in a liquid mobile phase through a stationary phase in a column, thereby causing the sample to separate into its components due to different partitioning between the mobile and stationary phases of each of the components (i.e. the components have different partition coefficients). The stationary phase is typically in the form of a bed of particles packed within the column, or in the form of a monolithic material held in the column.

A bed of non-porous particles has a relatively low sample capacity. Therefore, porous particles are commonly used which contain a network of pores to increase the surface area of the stationary phase and thus improve the capacity of the separation. The porous particles may be fully porous, wherein the pores extend throughout the bulk of the particles. As an alternative to fully porous particles, more recently use has been made of so-called fused core particles, which are also termed superficially porous particles. These are particles that have a non-porous core (also termed a fused or solid core) and are porous only in an outer layer or region that surrounds the non-porous core.

Silica particles are commonly used as the stationary phase, either as non-porous, fully porous or superficially porous particles.

Since Stöber et al. synthesized silica spheres by hydrolyzing alkylsilicates such as tetraethylorthosilicate, also termed tetraethoxysilane (TEOS), in mixed solutions of ammonia, alcohol and water in 1968, the sol-gel based wet-chemistry route to prepare silica spheres has widely been used. About 30 years later, Unger's group (Grun, M.; Lauer, I.; Unger, K. K.; Adv. Mater. 1997, 9, 254) successfully prepared ordered mesoporous silica spheres in the same system by introducing alkylammonium halide surfactants (e.g. C₁₆TAB), which has been initially and continually used as a sacrificial pore template for synthesizing ordered mesoporous silica materials. In this approach the surfactant is added into a hydrolysis solution at which point micelles are formed. Subsequent addition of a silica precursor facilitates the hydrolysis and condensation of the silica source around the micelles. Removal/extraction of the micelle produces a porous network within the particle. The latter process has been assigned as the “modified Stöber method”. The obtained so-called MCM-41 type spheres have shown superior performance to non-spherical MCM-41 particles when used as column filler materials in a high performance liquid chromatography (HPLC).

Hybrid silica material, wherein an organic functionality, for example alkyl, is incorporated in both the bulk and the surface of the silica, is also known as described in U.S. Pat. Nos. 4,017,528 and 6,686,035. Such approach comprises a polycondensation of a mixture of tetraethoxysilane (TEOS) and an organotriethoxysilane such as alkyltriethoxysilane. In such an approach, small precursor molecules are reacted to form the silica skeleton.

Surface modification of silica particles is also well established for producing apolar stationary phases. This comprises reacting the hydroxylated surface of the silica with a surface modifier such as a mono-, bi-, or tri-functional organochlorosilane for example.

Having regard to the silica particles formed by such approaches, there is a need to improve the stability of the silica particles for use as chromatographic material under a range of conditions, for example to improve pH resistance and chemical resistance, as well as improve thermal stability and mechanical robustness. Improved thermal stability permits use of higher temperatures that reduce mobile phase viscosity, leading to a wider range of mobile phase components, as well as faster flow rates that reduce analysis time. A wider range of pH stability of the stationary phase or solid support permits use of higher pH to suppress amine protonation and lower pH to suppress the ionization of acidic solutes. Without pH control both of these processes may lead to irreversible retention of solutes on the stationary phase.

Against this background the present invention has been made.

### SUMMARY OF THE INVENTION

According to an aspect of the present invention there is provided a particulate material comprising particles having a skeleton structure containing silsesquioxane moieties.

The particles are preferably silica particles having a skeleton structure containing silsesquioxane moieties. The silsesquioxane moieties have a cage structure.

According to another aspect of the present invention there is provided a method of preparing a particulate material comprising condensing at least a silsesquioxane to produce particles. The method comprises hydrolysing a silsesquioxane in a condensation reaction to produce silica particles having a skeleton structure containing silsesquioxane moieties having a cage structure. Preferably, the invention in such aspect resides in the use of a silsesquioxane as a co-component of a hydrolysis mixture to produce particles.

The particles are preferably silica particles. Preferably, the method of preparing a particulate material comprises co-condensing a silsesquioxane and a silane to produce the particles.

In yet another aspect of the present invention, there is provided a chromatography column packed with the particulate material, for example for use in liquid chromatography or solid phase extraction.

The present invention thus relates to the use of nanometer sized moieties (silsesquioxanes, also termed polyhedral oligomeric silsesquioxanes, commercially available under the trademark POSS) to make porous or non-porous particulate materials for chromatographic applications, e.g. as a stationary phase. The materials formed exhibit excellent pH resistance, high mechanical robustness, and greatly improved thermal stability compared to known chromatographic materials. The materials comprise silica or hybrid organo silica particles. Without being bound by any theory, the enhanced thermal, mechanical and pH stabilities (e.g. across a pH 1-11), may be attributed to the incorporation of rigid nano-sized silsesquioxane cages or cores in the silica.

### DESCRIPTION OF THE DRAWINGS

FIG. 1 shows schematically the structure of an exemplary inorganic silsesquioxane-silanol for forming inorganic silica particles in accordance with the present invention.

FIG. 2 shows schematically examples 1-6 of suitable organic silsesquioxane-silanols for the production of hybrid organic silica particles (R is an organic substituent).

FIGS. 3A and 3B show SEM images (x7k and x10k respectively) of particles obtained in Example 1 below.

FIGS. 4A and 4B show SEM images (x4k and x10k respectively) of particles obtained in Example 4 below.

FIGS. 5A and 5B show SEM images (x4k and x9k respectively) of particles obtained in Example 7 below.

### DETAILED DESCRIPTION OF THE INVENTION

The basic structure of the silsesquioxanes used in the present invention, also termed polyhedral oligomeric silsesquioxanes, can be viewed as a cage-like structure of molecular silica comprising a number of silicon atoms linked together with oxygen atoms in an orderly manner. The preferred “cage” silsesquioxanes of the present invention are thus compounds having a cage-like structure, generally a cubic cage structure. The silicon atoms are positioned at the corners of the cage. The cage typically comprises eight silicon atoms positioned at the corners of the cage linked together with oxygen atoms. In some embodiments, less or more than eight silicon atoms may be present in the cage, e.g. seven silicon atoms, or six silicon atoms. In such embodiments, one or more corners of the cage may be “missing” from the otherwise perfect cage structure. In general, a cage silsesquioxane may be a perfect cage or have one or more missing corners and optionally one or more (typically one) missing edge. Herein, cages may be referred to as an 8-silicon cage, 7-silicon cage, 6-silicon cage etc.

Preferably, one or more silicon atoms positioned at the corners of the cage carry a substituent selected from: hydroxyl, hydrogen and an organic group (especially a hydrocarbon, e.g. an alkyl or aryl). More preferably at each of the silicon corners of the cage is preferably a substituent, which can be hydroxyl, hydrogen, or an organic group (especially a hydrocarbon, e.g. an alkyl). Preferably, one or more silicon atoms, especially a plurality of silicon atoms, positioned at the corners carry a hydroxyl (silanol) group. In such embodiments, preferably the remainder of the silicon atoms at the corners carry an organic group. The organic substituents at the silicon corners of the cage may be selected from a hydrocarbon group (e.g. alkyl, aryl, which herein includes alkene, alkyne etc.). The organic substituents may contain S, OH, halide, amide, sulphonamide, ester, carboxylate, or sulfonate groups etc. Such organic substituents are defined in more detail below.

Cage silsesquioxanes wherein the corner silicon atoms carry only hydroxyl substituents, i.e. silanol groups, are useful for producing inorganic (“pure” or “non-hybrid”) silica. For example, the 8-silicon cage silsesquioxane with silanol groups at each corner is useful for making cage-consisting silica material that is non-hybrid (i.e. does not contain organic groups). The hydroxyl (silanol) groups are required for the condensation (polycondensation) reaction.

Non-porous, non-hybrid particles can also be made by calcination and/or sintering of hybrid organo-silica particles.

Conversely, hybrid organo-silica materials in this invention are made from cage silsesquioxanes having at least one corner silicon atom carrying an organic substituent as well as at least one silicon atom carrying a hydroxyl group. More preferably, one or more silicon atoms, especially a plurality of silicon atoms, positioned at the corners carry a hydroxyl group with at least the remainder of the silicon atoms at the corners carrying an organic group. In such embodiments, the cage structure preferably comprises seven or six corner silicon atoms and each corner silicon atom carries an organic group. Thus, further preferably, all of the silicon atoms at the corners carry an organic group and one or more of the corner silicon atoms, especially a plurality of corner silicon atoms, also carry a hydroxyl group. For example, cages with organic groups at the corners typically also have one or more corners missing (i.e. 7-silicon or 6-silicon cages) to provide the silanol groups necessary for the condensation reaction. Most preferably, in the hybrid organo-silica materials, the silsesquioxanes comprise cages wherein each corner silicon atom carries an organic group and a plurality of the silicon corner atoms also carry a hydroxyl group. Such silsesquioxanes are preferably 7-silicon or 6-silicon cages (most preferably 7-silicon cages).

Numerous nanometer sized cage silsesquioxane molecules can be prepared using well-established technology and many are readily commercially available from Hybrid Plastics under the trade mark POSS.

In the present invention, the nanometer sized molecules (i.e. the polyhedral oligomeric silsesquioxanes) are used to make a variety of novel porous or non-porous materials for chromatography applications. Unlike existing technology in which small molecules such as alkoxysilanes and alkylalkoxysilanes are used to make silica or hybrid silica/organo particles for chromatographic applications, the present invention employs the nanometer sized silsesquioxane molecules in the particle-making process so that silsesquioxane moieties are contained in the skeleton or internal structure of the silica, as well as on the surface. Thus, the skeletal units of the particle preferably contain Si-silsesquioxane-Si linkages. The resulting materials offer superior properties compared to those made by known methods, particularly in terms of one or more of pH, temperature, and/or mechanical stability.

Polyhedral oligomeric silsesquioxanes have been used previously in the synthesis of chromatographic material but not in the manner of the present invention. In one case, silsesquioxanes have been used as a stationary phase surface modifier as described in US 2012/0205315 A1. However, it was not suggested therein that silsesquioxanes could be used to form the silica particles themselves. In contrast, in the present invention, the silsesquioxane moieties are contained in the skeleton or internal structure of the silica, not merely on the surface.

Silsesquioxanes have also been used as a cross-linker for preparation of an inorganic-organic hybrid monolithic material as described in Wu, et al., Polyhedral Oligomeric Silsesquioxane as a Cross-linker for Preparation of Inorganic-Organic Hybrid Monolithic Columns, Analytical Chemistry (2010), 82(13), 5447-5454). In that case, the silsesquioxane was co-polymerized with an organic monomer to form a polymer-like monolithic material. In contrast, the present invention synthesizes nonporous or porous, pure silica or hybrid silica particles. The synthesis of monoliths and particles is very different and techniques for making one usually cannot be transferred to making the other. The method described in Wu, et al was designed to produce material for narrow capillary columns and such systems generally cannot be scaled up, for example due to the problem of wall attachment. The present invention is not limited to capillary columns. For example, the material according to the present invention may be used in HPLC applications where the column diameter is 1 mm or higher, e.g. in the range 1 to 10 mm, more particularly 2 to 5 mm, such as conventional HPLC diameter columns of 2.1 mm to 4.6 mm, or SPE applications where the column diameter is for example up to 10 mm. However, there are no particular limits of column dimension for the application of the present invention, which may be used from nano-scale to preparative-scale. The chromatography properties of the materials in the present invention differ from and are better controlled compared to the prior art monoliths.

Silsesquisiloxanes are synthesised by polymerising organotrialcoxysilane. The polymerisation occurs through the hydrolysis and condensation of the organotrialcoxysilane. Polymerisation leads to the formation of many siloxane rings with eight membered rings being the most stable. Further polymerisation produces polyhedral oligomeric structures. Today, silsesquisiloxanes are available as commercial starting materials.

The basic silsesquisiloxane structure can be viewed as a cage of molecular silica comprised of defined number of silicon atoms linked together with oxygen atoms in an orderly manner. At each corner is a substituent which can be a hydroxyl or just about any chemical group known in organic chemistry. Their three dimensionality, high symmetry, and size has been found to makes silsesquioxanes useful building blocks in the formation of silica particles according to the present invention. The diversity of possible functional groups along with their controlled orientation in three dimensional space allows for highly tailored nanometer-by-nanometer construction in all three dimensions. The silsesquioxane cage desirably confers rigidity and thermal stability that provides mechanical and thermal properties surpassing typical organic-silica hybrid materials. Combining the robust cage or core with the functionalities of the attached organic substituent groups can also change the physical properties of the compounds allowing for easier processing than typical ceramics. The mixture of organic and inorganic functionalities can lead to the creation of novel materials that exhibit properties superior to those of traditional materials. By varying the organic functionalities, there are practically an unlimited number of silsesquioxane variants. The hybrid organo silica particles according to the present invention thus comprise organic groups or moieties linked to silicon atoms of the silsesquioxane moiety. The organic moieties are preferably hydrocarbon moieties and especially alkyl or aryl moieties, as hereinafter described. As described below, such hydrocarbon moieties may be substituted hydrocarbon moieties.

The present invention in preferred embodiments comprises the incorporation of silsesquioxane molecules into a Stöber or modified Stöber process, i.e. via a co-condensation approach with a silane such as a tetraalkoxysilane (e.g. TEOS), to produce a variety of silica or hybrid silica particles, porous or non-porous, possessing the attractive physical properties described herein. In addition to this approach, other conventional silica particle making methods can be used. An example of another method includes the incorporation of silsesquisiloxane moieties into a polyethoxysilane (PEOS) of known molecular weight, e.g. by co-condensation of the same. The resultant hybrid polyethoxysilane (hybrid silsesquisiloxane-polyethoxysilane) is then suspended into an aqueous medium and gelled into porous particles, preferably in the presence of a base catalyst. A further example involves functionalisation of a silica sol with silsesquisiloxane moieties to form a hybrid sol, followed by emulsification of the hybrid sol in a non polar organic solvent with a surfactant to form emulsified beads. The emulsified beads can then be gelled using an acidic catalyst to form particles.

Various preferred features of the invention will now be described.

The silane used in co-condensing a silsesquioxane and a silane is preferably a tetraalkoxysilane, more preferably tetraethoxysilane (TEOS). Thereby, the silsesquioxane moieties in the silica particle preferably are linked via alkoxysilane linkages.

The condensing of the silsesquioxane and silane takes place preferably in a hydrolysis solution and more preferably in a basic medium. The hydrolysis solution preferably thus contains a base (which term also includes a mixture of bases) and more preferably ammonium hydroxide or an alkali metal hydroxide (e.g. sodium or potassium hydroxide), most preferably ammonium hydroxide. It should be understood, however, that although the use of basic conditions is preferred in the present invention, silica can also be formed under acidic conditions as known in the art.

The hydrolysis solution preferably comprises water and an organic solvent. The organic solvent preferably comprises an alcohol and more preferably comprises ethanol. A hydrolysis solution of water and ethanol is thus preferred.

The hydrolysis solution preferably contains a template for providing a porous structure. The hydrolysis solution preferably contains a surfactant template (which term also includes a mixture of surfactant templates). The surfactant serves as a porogen template, which once removed (e.g. burnt out) provides the porous structure. The surfactant is preferably water-soluble. The surfactant preferably forms micelles under the hydrolysis and condensation conditions of the process. The surfactant may be ionic or non-ionic, but preferably is ionic and more preferably cationic. Preferred surfactants are cationic, quaternary ammonium surfactants, more preferably with either bromide or chloride counter-ions, with more preferred examples being of a formula: (R₄)(R₅)(R₆)(R₇)(N)⁺X⁻, where each of R₄, R₅, R₆, R₇ is independently selected from H, alkyl, alkenyl, alkynyl, benzyl and aryl (especially alkyl), each of which may be unsubstituted or substituted (preferably each R₄, R₅, R₆, is independently an alkyl group and R₇ is an alkyl or benzyl group (especially an alkyl group)) and X is Br or Cl. Especially, at least one of R₄, R₅, R₆, R₇ is a C₈₋₂₀ alkyl group (unsubstituted or substituted). More especially, each R₄, R₅, R₆, is independently a C₁₋₂ alkyl group (especially methyl) and R₇ is a C₈₋₂₀ alkyl group. Especially preferred examples are alkyltrimethylammonium bromide or chloride, more especially (C₈₋₂₀alkyl)trimethylammonium bromide or chloride, with lauryl (C₁₂), myristyl (C₁₄), and cetyl (hexadecyl) (C₁₆) and stearyl (C₁₈) and didecyl (C₂₀) analogues most preferred, with cetyltrimethylammonium bromide (CTAB) and/or cetyltrimethylammonium chloride (CTAC) being especially good examples.

The co-condensation of silsesquioxane and silane typically initially results in the formation of a sol. The sol can then be gelled, e.g. by agitation, to form a precipitate of silica particles which can be separated from the solution. Advantageously, the formation of the sol and the gelation to form particles may be performed in a single pot, i.e. as a one-pot process. The separated silica precipitate can be optionally washed and dried. The surfactant can be removed from the silica particles, e.g. by acid extraction and/or burnt out by heat. The silica particles may be calcined prior to chromatographic use.

The order of addition and/or mixing of reagents is not especially limited. However, in a preferred protocol, the surfactant is dissolved in the solution comprising water and an organic solvent along with the base and then a mixture of the silsesquioxane and the silane is added to the solution to form a sol. The silsesquioxane/silane mixture may be dissolved in an organic solvent, such as ethanol, prior to addition to the hydrolysis solution.

In one example, the method includes (i) preparing a surfactant-containing hydrolysis solution of water, organic solvent (e.g. ethanol) and surfactant (e.g. hexadecyltrimethylammonium bromide), (ii) providing a base (e.g. ammonium hydroxide) in said surfactant solution, (iii) preparing a precursor solution of a mixture of tetraalkoxysilane (e.g. TEOS) and silsesquioxane, and (iv) adding the precursor solution to the hydrolysis solution thereby co-condensing the tetraalkoxysilane and silsesquioxane and forming particles. The particles can be washed and dried and the surfactant can be removed from the silica particles to leave a porous structure in the particles. Where the silsesquioxane carries an organic substituent, hybrid organo silica particles are formed. Where the silsesquioxane does not carry an organic substituent, pure inorganic silica particles are formed. Adjustment of the ratio of TEOS to silsesquioxane, wherein the silsesquioxane carries an organic substituent, can give a range of % carbon (% C) in the formed particles. An example silsesquioxane is a disilanol alkyl silsesquioxane or trisilanol alkyl silsesquioxane, e.g. trisilanol isooctyl silsesquioxane. The silanol groups on the molecule render the moiety available for co-condensation in the reaction. Adjustment of the hydrolysis solution concentrations and the condensation reaction temperature can provide a range of particle sizes.

It can be seen from the described reaction conditions that the invention preferably utilises a Stöber approach for making the (non-porous) particles and preferably a modified Stöber approach that facilitates the production of porous particles. Such approach may be performed as a one-pot process.

The formed silica particles may be subjected to one or more further treatments, e.g. pore expansion, calcination, and/or sintering. A pore expansion step (e.g. on non-calcined particles) preferably may comprise hydrothermal treatment of the particles. The pore-expanded particles may be subsequently calcined and/or sintered.

The silsesquioxane used in the present invention is not especially limited. Different silsesquioxanes may be selected to impart different properties to the silica particles. One species of silsesquioxane molecule may be used in the present invention to form the particles, or two or more different species of silsesquioxane molecule may be used.

Generally, any silsesquioxane may be used, which is capable of reacting with the co-component of the hydrolysis mixture, e.g. the alkoxysilane.

Porous and non-porous silica particles may be formed using silsesquioxane-silanol molecules as a co-component in the process. In silsesquioxane-silanol molecules, one or more of the silicon atoms (preferably two or more, or three or more of the silicon atoms) carries a hydroxyl substituent. In this way the silsesquioxane can take part in the co-condensation reaction to form the sol. In certain preferred embodiments, one or more of the silicon corner atoms is missing from the silsesquioxane cubic cage structure, i.e. the cage comprises seven silicon atoms or fewer. Such silsesquioxanes with a missing silicon corner and having seven silicon atoms suitably have silanol substituents on the silicon atoms that would otherwise be attached to the silicon atom of the missing corner. The other silicon atoms may have a hydroxyl substituent or, where is it desired to form hybrid silica, an organic substituent. It will be appreciated that the silsesquioxane-silanols may be used as a salt form thereof.

Porous and non-porous pure (i.e. inorganic) silica particles may be formed using silsesquioxane-silanol molecules that do not carry an organic substituent on the silicon atoms. Porous and non-porous hybrid silica/organo particles may be formed using nano-sized silsesquioxane-silanol molecules that have an organic substituent on one or more of the silicon atoms of the silsesquioxane. In this way, the invention provides a method of introduction of different chemical moieties into the skeleton or substructure of the silica particle that modify its chemical, thermal and pH stability.

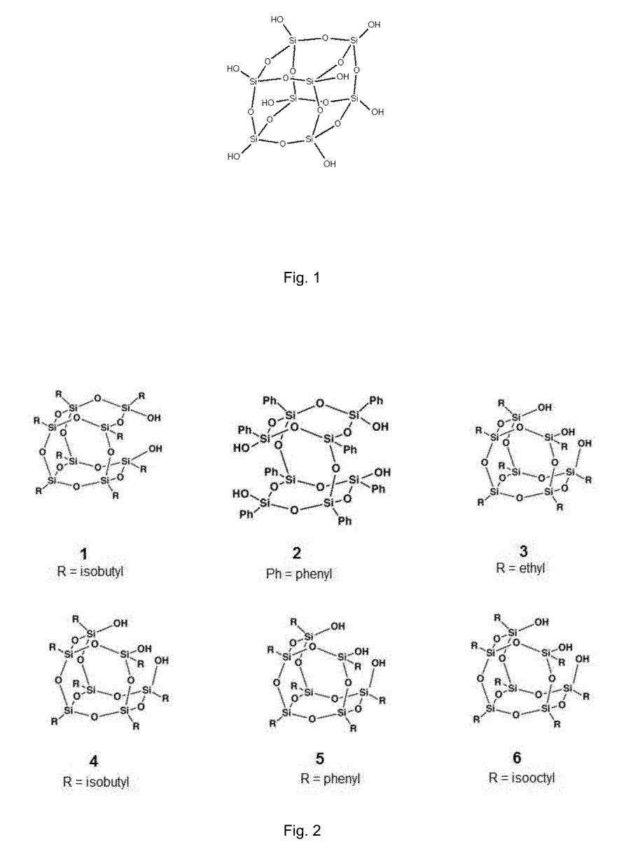

The silsesquioxane-silanols are preferred starting materials as moieties to be incorporated into the silica particles by co-condensation with alkoxysilanes. For the production of inorganic silica particles, the silsesquioxane-silanols having no organic substituent may be used (“inorganic silsesquioxane-silanols”). The structure of an exemplary inorganic silsesquioxane-silanol for forming inorganic silica particles is shown in FIG. 1. The molecule shown has eight silicon atoms in the cage structure each silicon carrying a hydroxyl group. Other inorganic silsesquioxane-silanols may have seven silicon atoms, or fewer. The silsesquioxane-silanol may be provided or used in a salt form thereof, e.g. as an ammonium salt or other salt thereof, such as the tetramethyl ammonium (TMA) salt of the octa-silanol silsesquioxane shown in FIG. 1.

For the production of hybrid organic/silica particles, silsesquioxane-silanols having an organic substituent (“organic silsesquioxane-silanols”) may be used. In FIG. 2 is shown examples of suitable organic silsesquioxane-silanols:

1 disilanol-isobutyl-silsesquioxane, R=isobutyl (C₃₂H₇₄O₁₃Si₈)

2 tetrasilanol-phenyl-silsesquioxane, R=phenyl (C₄₈H₄₄O₁₄Si₈)

3 trisilanol-ethyl-silsesquioxane, R=ethyl (C₁₄H₃₈O₁₂Si₇)

4 trisilanol-isobutyl-silsesquioxane, R=isobutyl (C₂₈H₂₆O₁₂Si₇)

5 trisilanol-phenyl-silsesquioxane, R=phenyl (C₄₂H₃₈O₁₂Si₇)

6 trisilanol-isooctyl-silsesquioxane, R=isooctyl

The present invention may employ one silsesquioxane species or a mixture of two or more silsesquioxane species, i.e. the particles may comprise in their skeleton structure two or more different silsesquioxane moieties.

The molar ratio of alkoxysilane to silsesquioxane in the starting materials and/or final particles may be in the range 1:x, that is 1 mole of alkoxysilane to x mole of silsesquioxane, where x is from 0.01 to 3, preferably from 0.02 to 2, more preferably from 0.1 to 1.5, especially 0.1 to 1, or 0.3 to 1.

The organic group or substituent on the silsesquioxane or silsesquioxane-silanol is preferably a hydrocarbon and more preferably is selected from the following group: alkyl and aryl.

Herein the term “alkyl,” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (i.e., C₁-C₁₀ means one to ten carbons). Examples of saturated hydrocarbon radicals include, but are not limited to, groups such as methyl, ethyl, n-propyl (e.g., —CH₂—CH₂—CH₃, —CH₂—CH₂—CH₂—), isopropyl, n-butyl, tbutyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below, such as “heteroalkyl”. Alkyl groups that are limited to hydrocarbon groups are termed “homoalkyl”. The term “alkyl” can also mean “alkylene” or “alkyldiyl” as well as alkylidene in those cases where the alkyl group is a divalent radical.

Herein the term “alkylene” or “alkyldiyl” by itself or as part of another substituent means a divalent radical derived from an alkyl group, as exemplified, but not limited, by —CH₂CH₂CH₂— (propylene or propane-1,3-diyl), and further includes those groups described below as “heteroalkylene”. Typically, an alkyl (or alkylene) group will have from 1 to about 30 carbon atoms, preferably from 1 to about 25 carbon atoms, more preferably from 1 to about 20 carbon atoms, even more preferably from 1 to about 15 carbon atoms and most preferably from 1 to about 10 carbon atoms. A “lower alkyl”, “lower alkylene” or “lower alkyldiyl” is a shorter chain alkyl, alkylene or alkyldiyl group, generally having about 10 or fewer carbon atoms, about 8 or fewer carbon atoms, about 6 or fewer carbon atoms or about 4 or fewer carbon atoms.

Herein the term “alkylidene” by itself or as part of another substituent means a divalent radical derived from an alkyl group, as exemplified, but not limited, by CH₃CH₂CH₂═ (propylidene). Typically, an alkylidene group will have from 1 to about 30 carbon atoms, preferably from 1 to about 25 carbon atoms, more preferably from 1 to about 20 carbon atoms, even more preferably from 1 to about 15 carbon atoms and most preferably from 1 to about 10 carbon atoms. A “lower alkyl” or “lower alkylidene” is a shorter chain alkyl or alkylidene group, generally having about 10 or fewer carbon atoms, about 8 or fewer carbon atoms, about 6 or fewer carbon atoms or about 4 or fewer carbon atoms.

Herein the terms “alkoxy,” “alkylamino” and “alkylthio” (or thioalkoxy) are used in their conventional sense, and refer to those alkyl groups attached to the remainder of the molecule via an oxygen atom, an amino group, or a sulfur atom, respectively.

Herein the term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si, S and B, and wherein the nitrogen and sulfur atoms may optionally be oxidized and the nitrogen heteroatom may optionally be quaternized. The heteroatom(s) O, N, B, S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NHCH₃, —CH₂—CH₂—N(CH₃)—CH₃, —CH₂—S—CH₂—CH₃, —CH₂—CH₂,—S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Optionally, for alkylene and heteroalkylene linking groups, no orientation of the linking group is implied by the direction in which the formula of the linking group is written. For example, the formula —CO₂R′— optionally represents both —C(O)OR′ and —OC(O)R′.

Herein the terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like.

Herein the terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

Herein the term “aryl” means, unless otherwise stated, a polyunsaturated, aromatic, substituent that can be a single ring or multiple rings (preferably from 1 to 3 rings), which are fused together or linked covalently. The term “heteroaryl” refers to aryl groups (or rings) that contain from one to four heteroatoms selected from N, O, S, Si and B, wherein the nitrogen and sulfur atoms are optionally oxidized, and the nitrogen atom(s) are optionally quaternized. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

For brevity, herein the term “aryl” when used in combination with other terms (e.g., aryloxy, arylthioxy, arylalkyl) includes both aryl and heteroaryl rings as defined above. Thus, the term “arylalkyl” is meant to include those radicals in which an aryl group is attached to an alkyl group (e.g., benzyl, phenethyl, pyridylmethyl and the like) including those alkyl groups in which a carbon atom (e.g., a methylene group) has been replaced by, for example, an oxygen atom (e.g., phenoxymethyl, 2-pyridyloxymethyl, 3-(1-naphthyloxy)propyl, and the like).

Each of the above terms (e.g., “alkyl,” “heteroalkyl,” “aryl” and “heteroaryl”) are meant to include both substituted and unsubstituted forms of the indicated radical. Preferred substituents for each type of radical are provided below.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) are generically referred to as “alkyl group substituents,” and they can be one or more of a variety of groups selected from, but not limited to: substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —OS(O)₂R′, —S(O)₂NR′R″, —NRSO₂R′, —CN and —NO₂ in a number ranging from zero to (2m′+1), where m′ is the total number of carbon atoms in such radical. R′, R″, R″′ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Similar to the substituents described for the alkyl radical, substituents for the aryl and heteroaryl groups are generically referred to as “aryl group substituents.” The substituents are selected from, for example: substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)′NR″″, —NR—C(NR′R″)═NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R′″ and R″″ groups when more than one of these groups is present.

In the present invention, the silsesquioxane moieties are contained in the skeleton structure of the silica, not merely on the surface of the silica, although silsesquioxane moieties may be present at the surface as well.

The inorganic (pure) silica particles according to the invention preferably have a formula:

SiO₂/[SiO_{3/2}]ₙ where n=0.01-3, preferably n=0.02-1.

The hybrid organo silica particles according to the invention preferably have a formula selected from the group consisting of:

SiO₂/[RSiO_{10/8}]ₙ

SiO₂/[RSiO_{11/8}]ₙ

SiO₂/[RSiO_{11/8}]ₙ

where n=0.01-3, preferably n=0.02-1; R is the organic (preferably hydrocarbon) moiety on the (corner(s) of the) silsesquioxane moiety.

Preferred silsesquioxane moieties have a missing corner or missing edge.

It can be seen from the description herein that numerous preferred approaches are envisaged by the present invention. Approach 1: using cage silsesquioxanes having only silanol groups at the corners and not organic groups, e.g. octa-silsesquioxanes (eight silanol groups at the corners) as an additive or co-component in making porous silica particles, preferably using TEOS as a co-component. Approach 2: using cage silsesquioxanes having only silanol groups at the corners and not organic groups, e.g. octa-silsesquioxanes (eight silanols) as an additive or co-component in making non-porous silica particles, preferably using TEOS as a co-component. The resulting materials from approaches 1 and 2 will be “pure”, i.e. inorganic, silica with enhanced mechanical, thermal, and chemical stability. Approach 3: using di-, tri, and/or tetra silanol hydrocarbon silsesquioxanes as additives or co-component in making porous silica particles, preferably using TEOS as a co-component. Approach 4: using di, tri-, and/or tetra silanol hydrocarbon silsesquioxanes as additives or co-component in making non-porous organo silica particles, preferably using TEOS as a co-component. The resulting materials from approaches 3 and 4 will be organo-silica hybrid material with enhanced mechanical, thermal, and chemical stability.

Hybrid silica particles have desirable properties for many applications, i.e. hybrid silica wherein an organic, especially alkyl, functionality is incorporated into the skeleton structure, optionally and the surface of the silica.

The particulate material of the present invention is desirably chromatographic material for use, e.g., in LC or SPE applications. The material may be used in nano-LC, analytical-LC, or preparative scale LC. In various embodiments, multiple particles are disposed in a packed bed. For example, a plastic or metal column is packed with the particles.

The silica or hybrid silica particles are typically and preferably substantially spherical but may be irregular in shape in some embodiments. The silica or hybrid silica particles preferably have a narrow size distribution.

In certain examples, the silica particles are essentially “monodisperse” or essentially “homodisperse”, which indicates that the particle size of the majority of the particles (e.g., 80, 90 or 95% of the particles) does not vary substantially (e.g., not more than 10%) below or above the median particle size (D₅₀). In an exemplary monodisperse particle population, 90% of the particles have an average particle size of between about 0.9×D₅₀ and about 1.1×D₅₀. This is advantageous for chromatographic applications. Whilst monodispersed particles are preferred, particles with a broader particle size distribution may be useful in many applications.

The silica particles are typically microparticles, preferably 0.1 μm or larger in diameter, preferably up to 1000 μm in median particle diameter. More preferably the particles are from 1 to 1000 μm, or 0.1 to 500 μm or 1 to 500 μm in diameter, or still more preferably 0.1 to 100 μm or 1 to 100 μm in diameter, or even more preferably 0.2 to 50 μm in diameter, especially 0.1 to 10 μm or 1 to 10 μm and most preferably 1.5 to 5 μm in diameter.

The particles may be porous (including partially porous, totally porous or superficially porous) or non-porous particles. The particles may be useful for preparing solid core chromatographic materials.

When porous particles are formed, the pores of the particles can be of any size. The nominal pore size is typically measured in angstroms (10⁻¹⁰ m, Å). A pore size distribution (PSD) is calculated from adsorption data using the BJH (Barrett Joyner-Halenda) method and the average pore size (W_{BJH}) is defined as the maximum of the PSD. In one example, the average size or diameter of the pores is between about 1 and about 5000 Å. In another example, the volume average diameter of the pores is between about 10 and about 5000 Å, between about 10 and about 4000 Å, between about 10 and about 3000 Å, between about 10 and about 2000 Å, between about 10 and about 1000 Å, between about 10 and about 800 Å, between about 10 and about 600 Å, between about 10 and about 500 Å, between about 10 and about 400 Å, between about 10 and about 300 Å, between about 10 and about 200 Å, between about 10 and about 100 Å, between about 20 and about 2000 Å, between about 20 and about 1000 Å, between about 20 and about 500 Å, between about 20 and about 300 Å, between about 20 and about 200 Å, between about 20 and about 100 Å, between about 30 and about 2000 Å, between about 30 and about 1000 Å, between about 30 and about 500 Å, between about 30 and about 300 Å, between about 30 and about 200 Å, between about 30 and about 100 Å, between about 40 and about 2000 Å, between about 40 and about 1000 Å, between about 40 and about 500 Å, between about 40 and about 300 Å, between about 40 and about 200 Å, between about 40 and about 100 Å, between about 50 and about 2000 Å, between about 50 and about 1000 Å, between about 50 and about 500 Å, between about 50 and about 300 Å, between about 50 and about 200 Å, between about 50 and about 100 Å, between about 60 and about 2000 Å, between about 60 and about 1000 Å, between about 60 and about 500 Å, between about 60 and about 300 Å, between about 60 and about 200 Å, between about 60 and about 100 Å, between about 70 and about 2000 Å, between about 70 and about 1000 Å, between about 70 and about 500 Å, between about 70 and about 300 Å, between about 70 and about 200 Å, between about 70 and about 100 Å, between about 80 and about 2000 Å, between about 80 and about 1000 Å, between about 80 and about 500 Å, between about 80 and about 300 Å, between about 80 and about 200 Å, between about 100 and about 200 Å, between about 100 and about 300 Å, between about 100 and about 400 Å, between about 100 and about 500 Å, between about 200 and about 500 Å or between about 200 and about 600 Å. Preferably, the average pore size is between about 30 and about 2000 Å, more preferably between about 80 and about 1000 Å. Most preferably, the average pore size is between about 80 and about 300 Å.

The (BET) specific surface area of the particulate material is typically between about 0.1 and about 2,000 m²/g. For example, the specific surface area of the particulate material is between about 1 and about 1,000 m²/g, between about 1 and about 800 m²/g, between about 1 and about 600 m²/g, between about 1 and about 500 m²/g, between about 1 and about 400 m²/g, between about 1 and about 200 m²/g or between about 1 and about 100 m²/g. In another example, the specific surface area of the material is between about 10 and about 1,000 m²/g, between about 10 and about 800 m²/g, between about 10 and about 600 m²/g, between about 10 and about 500 m²/g, between about 10 and about 400 m²/g, between about 10 and about 200 m²/g or between about 10 and about 100 m²/g. In another example, the specific surface area of the material is between about 50 and about 1,000 m²/g, between about 50 and about 800 m²/g, between about 50 and about 600 m²/g, between about 50 and about 500 m²/g, between about 50 and about 400 m²/g, between about 50 and about 200 m²/g or between about 50 and about 100 m²/g. Preferably, the specific surface area of the particulate material is between about 1 and about 500 m²/g, or between about 10 and about 500 m²/g (especially between about 50 and about 500 m²/g). In another example, the specific surface area more preferably is between about 10 and about 100 m²/g.

For non-porous particles, the specific surface area preferably is between about 0.5-10 m²/g. For non-porous particles, the median particle diameter is preferably from 0.1 to 5 μm.

It will be appreciated that surface modification of the produced silica or hybrid silica particles is possible using known methods of surface modifying silica particles for use as stationary phase materials. The silica or hybrid silica particles, for example, may be C18 surface modified. The silica or hybrid silica particles in certain embodiments may even be surface modified using silsesquioxane moieties as described in US 2012/0205315 A1. The same or different silsesquioxane could used as a surface modifier as used to form the skeleton of the silica particles. Thus, these molecules can be used to introduce new features into both the bulk and surface of particles for chromatography applications, in order to deliver higher thermal stability, higher pH stability, improved mechanical stability and chemical robustness.

The advantages of the materials in accordance with the present invention may include: rugged chemical stability, improved temperature stability, high physical strength, high pH stability, and a greener synthetic process (e.g. using less of volatile and toxic silane reagents). The materials provide a platform for a variety of high-performance separation media.

### DESCRIPTION OF EXAMPLES

In order to enable further understanding of the invention, but without limiting the scope thereof, various exemplary embodiments of the invention are now described with reference to the accompanying drawings.

### Materials and Methods

In the examples, tetraethylorthosilicate, also known as tetraethoxysilane (TEOS), ethanol (absolute preservative free), acetic anhydride (reagent grade) and hexadecyltrimethylammonium bromide (CTAB, 98%) were all purchased from Sigma Aldrich (UK). Ammonium hydroxide solution (35% wt NH₃) and toluene (reagent grade) were purchased from Fisher (Loughborough, UK). Isooctyl trisilanol silsesquioxane, iso-butyl trisilanol silsesquioxane, phenyl disilanol silsesquioxane, phenyl trisilanol silsesquioxane and octa TMA silsesquioxane (trade name POSS) were all purchased from Hybrid Plastics (Hattlesburg, US). All chemicals, solvents and reagents were used as received without further purification. De-ionised (DI) water was provided in house.

Nitrogen sorption measurements were performed on a Micromeritics ASAP 2020 volumetric analyzer. Prior to measurement, samples were degassed at 200° C. for 12 h. The specific surface area was calculated using the BET (Brunauer Emmett-Teller) method. The pore size distribution was calculated from adsorption data using the BJH (Barrett Joyner-Halenda) method. The average pore size (W_{BJH}) is defined as the maximum of the PSD. Scanning electron microscopy (Hitachi TM-100) was used to obtain images of the silica microspheres.

Particle size distributions (PSD) were measured using the electrical sensing zone (ESZ) technique on a Beckmann Multisizer 3 Coulter Counter as well as analysis via Centrifugal Particle Size (CPS) technique. D10 is defined as the particle diameter at 10% of the cumulative particle size distribution; D90 is defined as the particle diameter at 90% of the cumulative particle size distribution. D90/10 is defined as the ratio of the D90 value to the D10 value. % C composition was determined by Microanalysis using a LECO CS230 Carbon/Sulphur analyser.

### Synthesis of Porous Silica Particles

### Modified Stöber Method

### General Procedure

Mesoporous silica microspheres were synthesized in a simple batch process at room temperature. First, 0.785 g surfactant (CTAB) was dissolved in a solution containing 250 mL of DI water and 400 ml Abs ethanol in a 2 L round bottomed flask at room temperature (22° C.). The suspension was allowed to mix by slow magnetic stirring (200 rpm) for 1 hour. 10 ml of NH₄OH (25%) was added to the mixture and stirred for a further 15 minutes to make the hydrolysis solution before the one step addition of a pre-mixed solution of 3.56 mL TEOS and x ml (x=either 0.44 or 2 ml) POSS resulting in a sol with the following molar ratio: 1 mole TEOS:0.022-0.3 moles POSS:0.12 moles CTAB:754 moles H₂O:372 moles EtOH:moles 7.3NH₃. In general, the molar ratio of alkoxysilane to silsesquioxane (POSS) in the starting material and/or particle may be in the range 1:x, where x is from 0.01 to 3, preferably from 0.02 to 2, more preferably from 0.1 to 1.5, especially 0.1 to 1, or 0.3 to 1. The sol was allowed to stir for 24 h at 300 rpm. The silica precipitate was separated by centrifugation (3700 rpm—5 minutes), washed with methanol (5 times) and dried at 80° C. (heating rate 0.2° C./min) for 16 hours. The surfactant was removed by acid extraction involving 1 g of the silica spheres added to a solution of 150 ml absolute ethanol and 1.7 ml Concentrated HCl. The acid solution was heated to 60° C. and allowed to react for 24 hours. This procedure was repeated twice further.

### Example 1

The reaction followed the general procedure described above but with a slight variation. The TEOS and POSS were dissolved in ethanol prior to addition to the hydrolysis solution. For this, a volume of ethanol equal to four times the volume of the combined precursors was used (i.e. 3.56 ml TEOS and 0.44 ml POSS (4 ml total) were dissolved in 16 ml of ethanol), which was taken from the total ethanol content (i.e. 384 ml instead of 400 ml of ethanol was mixed with 250 ml DI H₂O to constitute the hydrolysis solution). The rationale behind this is that at least the TEOS diffusion into the hydrolysis solution is significantly aided by dilution prior to mixing under traditional Stöber conditions. Therefore, the decision was taken to dissolve the precursors prior to mixing.

### Example 2

In Example 2, the procedure of Example 1 was followed but the amounts of precursors were changed so that a 1:1 mixture was achieved. Therefore, Example 2's composition was 2 ml TEOS and 2 ml POSS. Both Examples 1 and 2 produced spherical particles with a wider particle size distribution normally associated with silica particles obtained under modified Stöber conditions. Both Examples 1 and 2 produced silica with high % C composition after synthesis (see results below).

### Examples 3-6

Examples 3-6 were focused on improving the resultant particle size distribution. The experimental protocol reverted back to the general procedure first described above, i.e. in these cases no pre-dilution of the precursors was performed. The TEOS and POSS reagents were mixed together in a glass vial and subjected to ultrasonic mixing for 2 minutes. After which the mixed precursors solution was added to the reaction flask. These Examples produced particles with a very narrow particle size distribution and mean particle diameter of ˜1.5 μm. Without being bound by any theory, it is believed that the alkyl, in these examples isooctyl, chains in the POSS compound, when added to the reaction mixture, help to stabilise the reaction medium, thereby allowing a stable emulsion to be formed and preventing serious particle aggregation. The % carbon composition was consistent with the results obtained from Example 1.

### Example 6a

### Calcination

A 1 g portion of the recovered material from Example 6 was placed in a furnace and heated to 560° C. (rate 1 K/min) for 24 hours (calcined). This step was performed because particle size measurement by Coulter technique has practical limitations. The particles recovered from Examples 1-6 had mean diameters of ˜1.4-1.5 μm when viewed under SEM and this size is at the lower limits of detection for the Coulter instruments. The reported D90/10 ratios for these samples also looked greater than what was observed under SEM. The CPS technique has a considerably broader detection range and in this instance offers more accurate results. However, the technique uses an aqueous sucrose solution to provide a suspension gradient for analysis. The silica particles in the hybrid organo silica form have too much hydrophobicity associated because of the co-condensed POSS inclusion that the recovered particles could not be analysed without removal of the organic functional groups. The calcination facilitated this and also indicated that non porous particles could be produced if the heating temperature was increased to sintering temperatures (>800° C.). Particles made via this method should posses Si—(SiO1.5)-Si linkages as opposed to the normal siloxane (Si—O—Si) linkages.

### Example 7

Example 7 was used to investigate increasing the recovered mean particle diameter whilst maintaining the narrow particle size distribution. This investigation used the known parameters of the traditional Stöber reaction to try and achieve this. Parameters such as lower reaction temperatures and reactant concentration changes can alter the final particle size. This experiment involved reducing the concentration of NH₃ catalyst into the system by 50%. The result from this experiment increased the final particle size from 1.4 μm to 1.8 μm whilst maintaining the final particle size distribution.

### Results

Selected measurements for Examples 1-7 are shown in Table 1. The terms SSA, MPV, and MPD represent the specific surface area, median pore volume, and median particle diameter, respectively.

TABLE 1

| | % C | % C | | | | | |
|---|---|---|---|---|---|---|---|
| Exam- | pre-ex- | post-ex- | SSA, | MPV | MPD, | D₅₀, | |
| ple | traction | traction | m²/g | cm³/g | nm | μm | D_{90/10} |
| 1 | 18.2 | 17.8 | 483 | 0.1 | 2.8 | 1.5* | 1.4* |
| 2 | 35 | 32 | | | | 1.5* | 1.4* |
| 3 | 18.099 | | | | | | |
| 4 | 18.25 | | | | | | |
| 5 | 18.5 | | | | | | |
| 6 | 17.99 | | | | | | |
| 6a | 0.005 | | 1000 | 0.22 | 2.2 | 1.47** | 1.16** |
| 7 | 18.12 | | | | | | |

*Measurement by Coulter Counter
**Measurement by Centrifugal Particle Sizer (CPS)

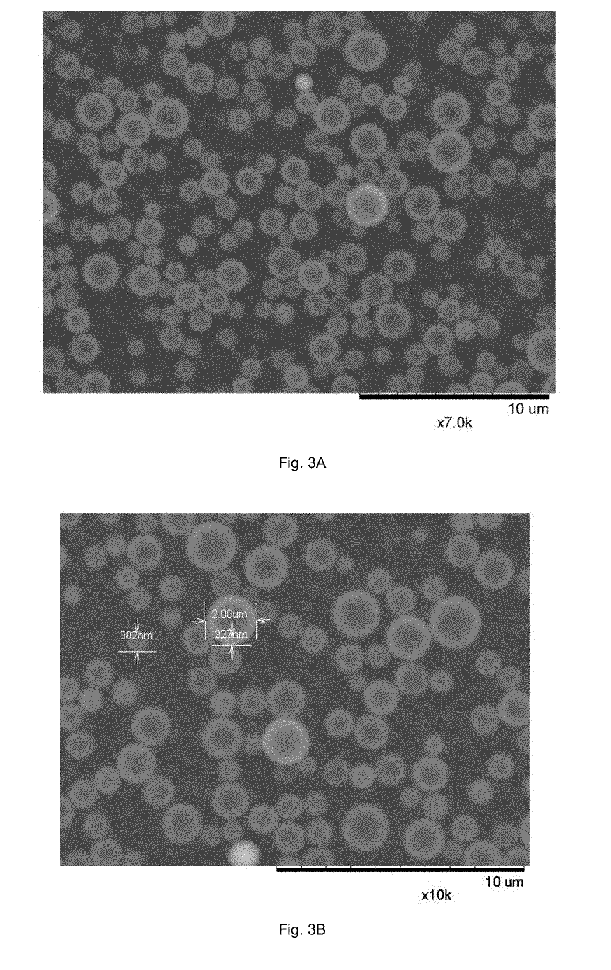

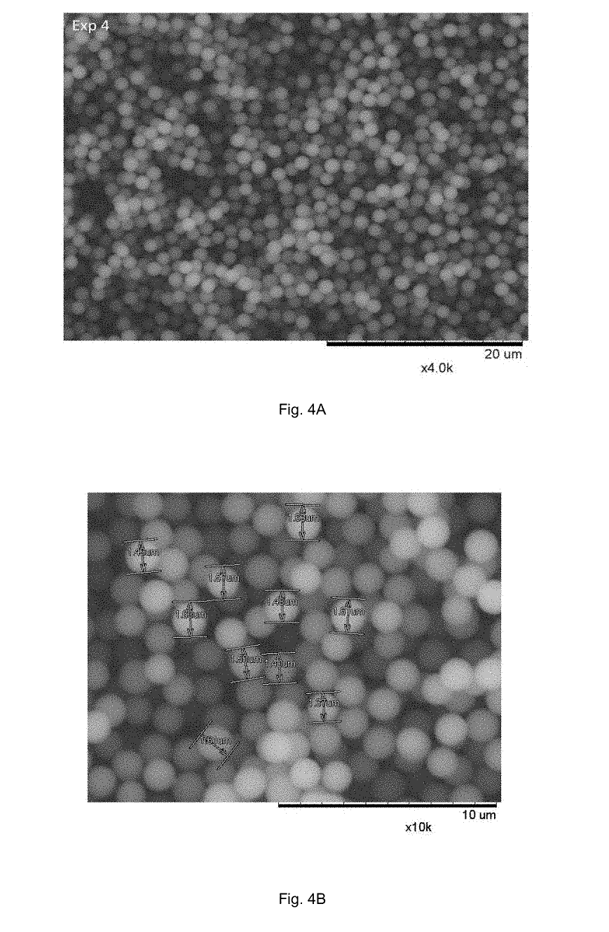

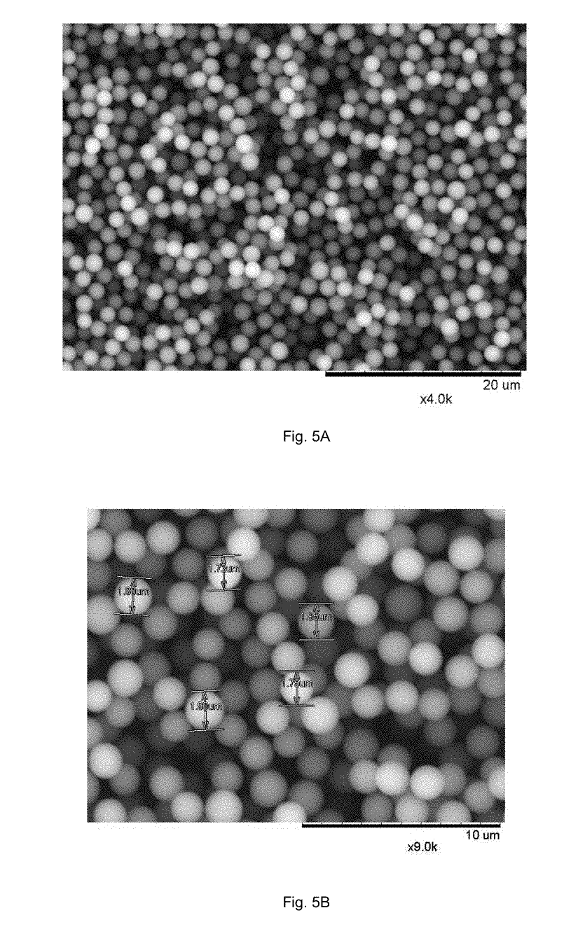

SEM images of particles obtained in Example 1 are shown in FIG. 3A (x7k) and FIG. 3B (x10k). A 10 μm scale is shown to indicate particle size and the particles are clearly spherical in shape. SEM images of particles obtained in Example 4 are shown in FIG. 4A (x4k) and FIG. 4B (x10k). A 20 μm or 10 μm scale is shown to indicate particle size and the particles are again clearly spherical in shape. SEM images of spherical particles obtained in Example 7 (reduced NH₃ catalyst) are shown in FIG. 5A (x4k) and FIG. 5B (x9k). The narrow particle size distributions are clearly evident from the SEM images.

The particles may be subject to further treatments. Numerous protocols are now described.

### Pore Expansion of Functional Hybrid Silica Particles from Examples 1-7

Non calcined particles are added to pre-prepared water:Dimethyldodecylamine (DMDA 3.3% v) emulsion system. After mixing for 1 hour the contents are transferred to an autoclave and hydrothermally heated to 130° C. for 3 days. The pore expanded particles are allowed to cool to room temperature and washed repeatedly with methanol, methanol:water (50%), methanol and Acetone, followed by drying overnight at 80° C.

Removal of Surfactant Template without Removal of Organic Functionality

The surfactant template is removed by repeated extraction using acidic ethanol solutions. 2 g of pore expanded silsesquioxane hybrid silica particles are suspended in absolute ethanol (150 ml) after which concentrated hydrochloric acid (1.7 ml) is added. The suspension is refluxed overnight. The particles are collected by centrifugation and repeatedly washed with ethanol. The extraction process is repeated 3 times followed by drying in oven at 80° C.

### Pore Expansion 2

A second pore expansion procedure may be performed by adding the particles to a mixture of DI water and tris(hydroxymethyl)aminomethane (TRIS). A typical example is as follows: 1.5 g of surfactant template extracted particles are dissolved in a solution of TRIS (0.4 g) and DI water (10 ml) and then hydrothermally treated at 135° C. for 24 hours followed by washing in DI water, methanol and acetone. The particles are dried at 80° C. overnight

Further examples of producing hybrid totally porous particles are also included within the scope of the invention. Such methods may require classification to produce narrow particle size distributions.

### Example 8

### Addition of Trisilanol Alkyl POSS (Iso-Butyl or Iso-Octyl POSS Version) to a PEOS Process to Make Mesoporous Particles

8.1 Preparation of Polyethoxysilane (PEOS)

Absolute, preservative free, 200 proof ethanol (445 ml) and tetraethoxysilane (233 ml) are mixed in a flask. 0.01 M HCl solution is slowly added to the mixture which is then refluxed for 16 hours under a nitrogen atmosphere. The mixture is distilled under vacuum to remove any excess ethanol followed by further heating under nitrogen at an elevated temperature of 125° C. for 2 hours. A colourless viscous liquid of polyethoxysilane results with a molecular weight of approximately 800.

8.2 Emulsification of Polyethoxysilane to Produce Porous Silica Particles.

A mixture of DI Water (480 ml) and iso-propanol IPA (160 ml) are mixed in a beaker using a Silverson LSM Homogeniser (4700 rpm). In a separate beaker trisilanol alkyl POSS (118.4 g) is added to polyethoxysilane (120 ml) and dimethylformamide (40 ml). The mixture is allowed to react for 20 minutes after which it is added to the stirred water/IPA solution and allowed to mix for 5 minutes. Ammonium hydroxide solution, 25% (50 ml) is added to the emulsion to gel the spherical beads with stirring for a further 3 minutes after which stirring is stopped. The particle suspension is then heated at 50° C. for 16 hours and the particles the collected by filtration and washed repeatedly with methanol, methanol:water (60:40 v:v), methanol and acetone. The particles are then dried in a vacuum oven at 80° C. for 24 hours.

### Example 9

### Addition of Trisilanol Alkyl-POSS (Iso-Butyl or Iso-C8 Version) to General Sol Gel Process Followed by Pore-Enlargement

9.1 General Sol Gel Emulsion Method for Forming Porous POSS Silica Spheres

To 80 ml of an aqueous silica sol consisting of 27% weight SiO₂, OctaTMA POSS (8 g) is added and allowed to mix for 30 minutes. An oil phase is prepared by dissolving 1.08 g of surfactant Span 80 and 1.08 g of stearic acid in toluene (250 ml). A Silverson LM homogeniser is used to make an emulsion. The stirrer is allowed to rotate at 6000 rpm and the silica/POSS sol is added to the oil phase and stirred for 15 minutes.

The silica sol turns to spherical droplets of 1 to 30 μm in diameter. Acetic acid anhydride (10 ml) is added into the emulsion over 30 seconds and the particles are allowed to stand overnight.

The silica gel slurry prepared this way is dispersed in methanol and again allowed to settle overnight. Toluene and emulsifier previously added are removed by repeatedly decanting the supernatant methanol solution.

### Example 10

### Modified Stöber Reaction Using Trisilanol POSS (of Any Type) Followed by Pore Expansion and Calcination

Totally porous pure silica particles containing silsesquioxane cages within the framework without any organic functionality can be obtained by the following process.

Mesoporous silica microspheres were synthesized in a simple batch process at room temperature. First, 0.785 g surfactant (CTAB) was dissolved in a solution containing 250 mL of DI water and 400 ml Abs ethanol in a 2 L round bottomed flask at room temperature (22° C.). The suspension was allowed to mix by slow magnetic stirring (200 rpm) for 1 hour. 10 ml of NH₄OH (25%) was added to the mixture and stirred for a further 15 minutes to make the hydrolysis solution before the one step addition of a pre-mixed solution of 3.56 mL TEOS and x ml (x=either 0.44 or 2 ml) POSS resulting in a sol with the following molar ratio: 1 mole TEOS:0.022-0.3 moles POSS:0.12 moles CTAB:754 moles H₂O:372 moles EtOH:moles 7.3NH₃. The sol was allowed to stir for 24 h at 300 rpm. The silica precipitate was separated by centrifugation (3700 rpm—5 minutes), washed with methanol (5 times) and dried at 80° C. (heating rate 0.2° C./min) for 16 hours.

10.1 Pore Expansion 1

The non calcined particles were then added to pre-prepared water:dimethyldodecylamine (DMDA 3.3% v) emulsion system. After mixing for 1 hour the contents were transferred to an autoclave and hydrothermally heated to 130° C. for 3 days. The pore expanded particles were allowed to cool to room temperature and washed repeatedly with methanol, methanol:water (50%), methanol and acetone, followed by drying overnight at 80° C.

10.2 Removal of Surfactant Template and Organic Functionality.

After drying the particles can be subjected to calcination to remove the surfactant template and the organic functionality of the POSS compound used. Calcination can be performed by heating the material in a suitable oven at 560° C. (heating rate 1° C./min) for 24 hours.

10.3 Pore Expansion 2

A second pore expansion procedure is performed by adding the particles to a mixture of DI water and tris(hydroxymethyl)aminomethane (TRIS). A typical example is as follows: 1.5 g of surfactant template extracted particles are dissolved in a solution of TRIS (0.4 g) and DI water (10 ml) and then hydrothermally treated at 135° C. for 24 hours followed by washing in DI water, methanol and acetone. The particles are dried at 80° C. overnight.

### Example 11

### Incorporation of Silsesquioxane (POSS) (Trisilanol) into PEOS Followed by Calcination

11.1 Preparation of Polyethoxysilane

Absolute, preservative free, 200 proof ethanol (445 ml) and tetraethoxysilane (233 ml) are mixed in a flask. 0.01 M HCl solution is slowly added to the mixture which is then refluxed for 16 hours under a nitrogen atmosphere. The mixture is distilled under vacuum to remove any excess ethanol followed by further heating under nitrogen at an elevated temperature of 125° C. for 2 hours. A colourless viscous liquid of polyethoxysilane results with a molecular weight of approximately 800.

11.2 Emulsification of Polyethoxysilane to Produce Porous Silica Particles.

A mixture of DI water (480 ml) and iso-propanol IPA (160 ml) are mixed in a beaker using a Silverson LSM Homogeniser (4700 rpm). In a separate beaker trisilanol POSS (118.4 g) is added to polyethoxysilane (120 ml) and dimethylformamide (40 ml). The mixture is allowed to react for 20 minutes after which it is added to the stirred water/IPA solution and allowed to mix for 5 minutes. Ammonium hydroxide solution, 25% (50 ml) is added to the emulsion to gel the spherical beads with stirring for a further 3 minutes after which stirring is stopped. The particle suspension was then heated at 50° C. for 16 hours and the particles the collected by filtration and washed repeatedly with methanol, methanol:water (60:40 v:v), methanol and acetone. The particles were then dried in a vacuum oven at 80° C. for 24 hours.

11.3 Calcination Removal of Organic Functionality.

After drying the particles are subjected to calcination to remove the organic functionality of the POSS compound used. Calcination is performed by heating the material in a suitable oven at 560° C. (heating rate 1° C./min) for 24 hours.

### Example 12

### Incorporation of POSS (OctaTMA) into General Sol Gel Method Followed by Calcination

12.1 General Sol Gel Emulsion Method to Produce Porous Hybrid Spheres.

To 80 ml of an aqueous silica sol consisting of 27% weight SiO₂, OCTMA POSS (8 g) is added and allowed to mix for 30 minutes. An oil phase is prepared by dissolving 1.08 g of surfactant Span 80 and 1.08 g of stearic acid in toluene (250 ml). A Silverson LM homogeniser is used to make an emulsion. The stirrer is allowed to rotate at 6000 rpm and the silica/POSS sol is added to the oil phase and stirred for 15 minutes.

The silica sol turns to spherical droplets of 1 to 30 μm in diameter. Acetic acid anhydride (10 ml) is added into the emulsion over 30 seconds and the particles are allowed to stand overnight.

The silica gel slurry prepared this way is dispersed in methanol and again allowed to settle overnight. Toluene and emulsifier previously added are removed by repeatedly decanting the supernatant methanol solution.

12.2 Calcination/Removal of Organic Functionality.

After drying the particles are subjected to calcination to remove the organic functionality of the POSS compound used. Calcination is performed by heating the material in a suitable oven at 560° C. (heating rate 1° C./min) for 24 hours.

### Example 13

### Stöber Process Incorporating Trisilanol POSS (Any Type) without Sintering

Non porous silica particles retaining organo functionality of incorporated POSS can be obtained by the following process. Absolute, preservative free, 200 proof ethanol (23 ml) and ammonium hydroxide solutions (25%, 5 ml) are mixed in a round bottom flask. In a separate vial, TEOS (0.49 ml) and the trisilanol POSS (0.1 ml) are mixed (sonication, 2 minutes) after which 2 ml of ethanol is added and the solution sonicated again. The TEOS/POSS/ethanol mixture is added to the ethanol/ammonium hydroxide solution with rapid stirring. The reaction is allowed to proceed for 16 hours. The particles are collected by centrifugation (3700 rpm, 5 minutes) and washed repeatedly with methanol and acetone followed by drying at 80° C. overnight.

### Example 14

### Seeded Growth of Stöber Nanoparticles with TEOS/Trisilanol POSS (of Any Type) without Sintering

A typical example of this process is as follows. Absolute, preservative free, 200 proof ethanol (750 ml) and ammonium hydroxide solution (25%, 200 ml) are mixed in a 2 litre round bottom flask under rapid stirring for 15 minutes at room temperature. Tetraethylorthosilicate (TEOS) (57 ml) is added to ethanol (228 ml) and thoroughly mixed. The TEOS:ethanol solution is then added to the Ethanol/ammonium hydroxide solution and the mixture allowed to react for 16 hours.

The freshly formed Stöber particles (600 nm) are transferred to a 3 litre 3 neck round bottom flask and heated to 40° C.

A hydrolysis solution consisting of Deionised (DI) water (360 ml), ethanol (400 ml) and ammonium hydroxide solution (25%, 240 ml) is made in a 1 L borosilicate HPLC bottle and sealed. TEOS (140 ml) and trisilanol POSS (60 ml) are mixed via sonication and added to 800 ml of ethanol in a second borosilicate bottle.

The separately prepared hydrolysis and TEOS/POSS solutions are attached to a continuous flow syringe pump (Atlas syringe pump, Syrris) and fed into the previously prepared Stöber silica particle suspension at flow rates of 5 ml/min each. The final particle size can be achieved after allowing the addition of the growth reagents over periods of time. For example, continuous addition for 3 hours facilitates the production of 1 μm POSS hybrid spheres with a D₉₀/D₁₀ ratio of 1.11. Upon completion of addition the particles are allowed to stir overnight, collected by centrifugation and suspended in water/methanol solution 50% v for 2 days, after which the particles are collected and washed repeatedly with methanol and acetone. The particles are then dried overnight at 80° C.

### Example 15

### Pure Silica Non Porous Particles which Posses POSS Cage in the Framework but No Organic Functionality

15.1 Stöber Process Incorporating Trisilanol POSS (Any Type) with Sintering

Non porous particles can be made via the incorporation of POSS compounds into the Stöber reaction. A typical example, which in no way limits the present invention, is as follows.

Absolute, preservative free, 200 proof ethanol (23 ml) and ammonium hydroxide solutions (25%, 5 ml) are mixed in a round bottom flask. In a separate vial, TEOS (0.49 ml) and trisilanol POSS (0.1 mL) are mixed (sonication, 2 minutes) after which 2 mL of ethanol is added and the solution sonicated again. The TEOS/POSS/ethanol mixture is added to the ethanol/ammonium hydroxide solution with rapid stirring. The reaction is allowed to proceed for 16 hours. The particles are collected by centrifugation (3700 rpm, 5 minutes) and washed repeatedly with methanol and acetone followed by drying at 80° C. overnight. The particles can be used as recovered or subject to sintering at elevated temperatures. Sintering will remove any of the organic functional groups associated to the POSS compound but the cage structure of the compound will remain within the silica framework.

15.2 Sintering Procedure.

A portion of the ‘as produced’ POSS Stöber particles are placed into a furnace (Carbolite 1100° C. Rapid heating box furnace) and heated to 1000° C. at a heating rate of 1° C./min. The particles are held at this temperature for 2 hours then allowed to cool to room temperature. This facilitates the formation of a particle diameter determined by centrifugal particle sizing of 400 nm with a D₉₀/D₁₀ ratio of 1.10 with a Specific Surface area (BET) of 4 m²/g.

### Example 16

### Seeded Growth of Stöber Nanoparticles with TEOS/POSS (Trisilanol POSS) Mixture Followed by Sintering

Non porous particles greater of mean particle diameter of 800 nm or greater can be produced via a seeded growth method. A seed solution of Stöber silica particles are firstly prepared and then grown to the desired final particle size via a continuous controlled seed growth procedure in which up to 30% of the precursor volume is replaced with appropriate POSS molecule, which in this example is Trisilanol Iso-Octyl POSS or Trisilanol Phenyl POSS.

A typical example is as follows. Absolute, preservative free, 200 proof ethanol (750 ml) and ammonium hydroxide solution (25%, 200 ml) are mixed in a 2 litre round bottom flask under rapid stirring for 15 minutes at room temperature. Tetraethylorthosilicate (TEOS) (57 ml) is added to ethanol (228 ml) and thoroughly mixed. The TEOS:ethanol solution is then added to the ethanol/ammonium hydroxide solution and the mixture allowed to react for 16 hours. The freshly formed Stöber particles (600 nm) are transferred to a 3 litre 3 neck round bottom flask and heated to 40° C.

A hydrolysis solution consisting of Deionised (DI) water (360 ml), ethanol (400 ml) and ammonium hydroxide solution (25%, 240 ml) is made in a 1 L borosilicate HPLC bottle and sealed. TEOS (140 ml) and Trisilanol POSS (60 ml) are mixed via sonication and added to 800 ml of ethanol in a second borosilicate bottle.

The separately prepared hydrolysis and TEOS/POSS solutions are attached to a continuous flow syringe pump (Atlas syringe pump, Syrris) and fed into the previously prepared Stöber silica particle suspension at flow rates of 5 ml/min each. The final particle size can be achieved after allowing the addition of the growth reagents over periods of time. For example, continuous addition for 3 hours facilitates the production of 1 μm POSS hybrid spheres with a D₉₀/D₁₀ ratio of 1.11.

Upon completion of addition the particles are allowed to stir overnight, collected by centrifugation and suspended in water/methanol solution 50% v for 2 days, after which the particles are collected and washed repeatedly with methanol and acetone. The particles are then dried overnight at 80° C. The dried particles are then subjected to sintering as in example 15.

### Example 17

### Modified Stöber Process with Trisilanol Alkyl-POSS (Iso-Butyl or Iso-C8 Version) Followed by Sintering

17.1 Modified Stöber Method

Typically, mesoporous silica microspheres were synthesized in a simple batch process at room temperature. Typically, 0.785 g surfactant (CTAB) was dissolved in a solution containing 250 mL of DI water and 400 ml Abs ethanol in a 2 L round bottomed flask at room temperature (22° C.). The suspension was allowed to mix by slow magnetic stirring (200 rpm) for 1 hour. 10 ml of NH₄OH (25%) was added to the mixture and stirred for a further 15 minutes to make the hydrolysis solution before the one step addition of a pre-mixed solution of 3.56 mL TEOS and x ml (x=either 0.44 or 2 ml) POSS resulting in a sol with the following molar ratio: 1 mole TEOS:0.022-0.3 moles POSS:0.12 moles CTAB:754 moles H₂O:372 moles EtOH:moles 7.3NH₃. The sol was allowed to stir for 24 h at 300 rpm. The silica precipitate was separated by centrifugation (3700 rpm—5 minutes), washed with methanol (5 times) and dried at 80° C. (heating rate 0.2° C./min) for 16 hours.

17.2 Sintering of Porous Modified Stöber Hybrid POSS Particles.

The recovered particles are then placed into a furnace (Carbolite high temperature box furnace) and heated to 1000° C. at a heating rate of 1° C./min. Particles obtained will typically have a mean particle diameter of 1.2 μm with a D90/D10 of 1.16 and a Specific Surface Area of 4 m²/g

### Example 18

### Addition of POSS (Any Type) to the PEOS Process to Make Mesoporous Particles Followed by Sintering

Absolute, preservative free, 200 proof ethanol (445 ml) and tetraethoxysilane (233 ml) are mixed in a flask. 0.01 M HCl solution is slowly added to the mixture which is then refluxed for 16 hours under a nitrogen atmosphere. The mixture is distilled under vacuum to remove any excess ethanol followed by further heating under nitrogen at an elevated temperature of 125° C. for 2 hours. A colourless viscous liquid of polyethoxysilane results with a molecular weight of approximately 800.

18.1 Emulsification of Polyethoxysilane to Produce Porous Silica Particles.

A mixture of DI Water (480 ml) and Iso-Propanol (IPA) (160 ml) are mixed in a beaker using a Silverson LSM Homogeniser (4700 rpm). In a separate beaker trisilanol iso octyl POSS (118.4 g) is added to polyethoxysilane (120 ml) and dimethylformamide (40 ml). The mixture is allowed to react for 20 minutes after which it is added to the stirred water/IPA solution and allowed to mix for 5 minutes. Ammonium hydroxide solution, 25% (50 ml) is added to the emulsion to gel the spherical beads with stirring for a further 3 minutes after which stirring is stopped. The particle suspension was then heated at 50° C. for 16 hours and the particles the collected by filtration and washed repeatedly with methanol, methanol:water (60:40 v:v), methanol and acetone.

18.2 Sintering of Porous Hybrid PEOS/POSS Particles.

The recovered particles are then placed into a furnace (Carbolite high temperature box furnace) and heated to 1000° C. at a heating rate of 1° C./min. Particles obtained typically have a mean particle diameter of 1.2 μm with a D90/D10 of 1.16 and a Specific Surface Area of 4 m²/g

### Example 19

### Addition of POSS (Any Type) to a General Sol-Gel Process for Making Followed by Sintering

To 80 ml of aqueous silica sol consisting of 27% weight SiO₂ particles OCTMA POSS (8 g) was added and allowed to mix for 30 minutes. An oil phase was prepared by dissolving 1.08 g of surfactant Span 80 and 1.08 g of stearic acid in toluene (250 ml). A Silverson LM homogeniser was used to make an emulsion. The stirrer was allowed to rotate at 6000 rpm and the silica/POSS sol was added to the oil phase and stirred for 15 minutes.

The silica sol turned to spherical droplets of 1 to 30 μm in diameter. Acetic acid anhydride (10 ml) was added into the emulsion over 30 seconds and the particles were allowed to stand overnight.

The silica gel slurry prepared this way is dispersed in methanol and again allowed to settle overnight. Toluene and emulsifier previously added are removed by repeatedly decanting the supernatant methanol solution.

19.1 Sintering

The recovered particles are then placed into a furnace (Carbolite high temperature box furnace) and heated to 1000° C. at a heating rate of 1° C./min.

### Results in Chromatography Column

The effectiveness of the above prepared particles in HPLC applications was confirmed by packing the particles from Example 1 in a column (50×2.1 mm) and resolving an RP-5 standard analyte mixture (theophylline, p-nitroaniline, phenetole, o-xylene, and methyl benzoate) in a mobile phase (50:50 MeCN:H₂O).

It can be seen that, using the method of the present invention, hybrid silica particles have been formed having very narrow particle size distributions. Consequently, this method can drastically reduce the overall synthesis time as very little or no classification of the particles is necessary. The measured surface areas of the silica particles are very high and the pore volume can be controlled by the concentration of the surfactant template in the reaction medium. Furthermore, known pore expansion methods may be employed with the particulate materials, for example post-synthesis hydrothermal treatments and/or the inclusion of pore swelling agents in the reaction medium to increase pore size. All N₂ isotherms displayed the typical Type 1 isotherm with H4 hysteresis typical to those obtained from MCM-41 type materials.

As used herein, including in the claims, unless the context indicates otherwise, singular forms of the terms herein are to be construed as including the plural form and vice versa. For instance, unless the context indicates otherwise, a singular reference, such as “a” or “an” means “one or more”.

Throughout the description and claims of this specification, the words “comprise”, “including”, “having” and “contain” and variations of the words, for example “comprising” and “comprises” etc, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example”, “e.g.” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

1. A liquid chromatography stationary phase comprising:
silica particles formed via co-condensation of a Si moiety of an alkoxysilane with a silsesquioxane moiety in a presence of a surfactant, a water, an organic solvent, and a base,
in which the silsesquioxane moiety has a cage structure,
in which the silica particles include Si-silsesquioxane-Si linkages,
in which the silica particles comprise an internal structure and a surface,
in which the silsesquioxane moieties are contained in the internal structure of the silica particles via the Si-silsesquioxane-Si linkages, and
in which the silica particles are configured to be packed into a chromatography column.

2. The liquid chromatography stationary phase of claim 1, wherein the silica particles are hybrid organo-silica particles, wherein the cage structure of the silsesquioxane moieties comprise silicon atoms positioned at corners of the cage structure, wherein one or more of the silicon atoms positioned at the corners of the cage structure include an organic group.

3. The liquid chromatography stationary phase of claim 2, wherein the organic group is a hydrocarbon group.

4. The liquid chromatography stationary phase of claim 2, wherein the hybrid organo silica particles have a formula selected from the group consisting of: SiO₂/[RSiO_{10/8}]ₙ, SiO₂/[RSiO_{11/8}]ₙ, and SiO₂/[RSiO_{11/7}]ₙ, where n=0.01-3; R is the organic group on the silsesquioxane moiety.

5. The liquid chromatography stationary phase of claim 1, wherein the silica particles are inorganic silica particles.

6. The liquid chromatography stationary phase of claim 5, wherein the inorganic silica particles have a formula: SiO₂/[SiO_{3/2}]ₙ where n=0.01-3.

12. The liquid chromatography stationary phase of claim 1, wherein the silica particles are porous, wherein the silica particles have a median particle diameter from 0.2 μm to 50 μm, and wherein the silica particles have an average pore size between about 80 Å and about 2000 Å, wherein the silica particles have a BET specific surface area between about 1 m²/g and about 500 m²/g.

13. The liquid chromatography stationary phase of claim 1, wherein the internal structure contains two or more different silsesquioxane moieties.

14. The liquid chromatography stationary phase of claim 1, in which the silica particles are not a monolithic material.

15. The liquid chromatography stationary phase of claim 1, in which the surfactant comprises a quaternary ammonium surfactant, the organic solvent comprises an alcohol, and the base comprises an ammonium hydroxide.

16. A method of preparing a liquid chromatography stationary phase, the method comprising:
forming silica particles via co-condensation of a Si moiety of an alkoxysilane with a silsesquioxane moiety in a presence of a surfactant, a water, an organic solvent, and a base, in which the silsesquioxane moiety has a cage structure,

17. The method of claim 16, in which the surfactant comprises a quaternary ammonium surfactant, the organic solvent comprises an alcohol, and the base comprises an ammonium hydroxide.

18. The method of claim 16, in which the silica particles are not a monolithic material.

19. The method of claim 16, in which the silsesquioxane moieties comprise an organic group and the silica particles are hybrid organo-silica particles.

20. The method of claim 16, in which the silsesquioxane moieties do not comprise an organic group and the silica particles are inorganic silica particles.
